(19) United States
(12) Patent Application Publication
(10) Pub. No.: US 2014/0252249 A1
(43) Pub. Date: Sep. 11, 2014

(54) METHOD OF OBTAINING A UNIFORM BEAM OF ELECTROMAGNETIC RADIATION OF ARBITRARY GEOMETRICAL SHAPE AND A MECHANICAL-OPTICAL DEVICE FOR APPLICATIONS OF THIS METHOD

(71) Applicants: Wieslaw Doros, Rzeszow (PL); Waldemar Szczepanik, Krakow (PL)

(72) Inventors: Wieslaw Doros, Rzeszow (PL); Waldemar Szczepanik, Krakow (PL)

(73) Assignee: DOROS TEODORA - D.A.GLASS, Rzeszów (PL)

(21) Appl. No.: 14/129,622

(22) PCT Filed: Jun. 25, 2012
(86) PCT No.: PCT/PL2012/000048

§ 371 Date: Jan. 27, 2014

(30) Foreign Application Priority Data
Jul. 13, 2011 (PL) P 395649

(51) Int. Cl. F21V 14/06; F21K 99/00

(52) U.S. Cl. CPC F21V 14/06; F21K 9/58
USPC 250/504 R; 362/311.01; 362/311.1; 362/311.09; 362/296.01; 362/235

(57) ABSTRACT

The method of obtaining a uniform beam of electromagnetic radiation with arbitrary geometrical shape by means of lens optical system consists in that a source of artificial light (2) emitting light is connected to the electric power network and electromagnetic light rays (20) are emitted by the source; then, depending on the required light projection shape (23-27) and (34-36), a uniform beam of electromagnetic radiation is directed onto appropriate input lens (3), preferably a cylindrical plano-convex lens with fixed or adjustable focal length “A”, and the light rays (21) coming out of the lens are directed onto an output set of lenses or an output panel set of lenses (4) with fixed or adjustable position with respect to the input lens (3), i.e. inclined at angle “a” ranging from 0° to 75°, and after passing through the lens or the panel set of lenses (4), the rays are directed onto the desired plane forming the required shape of light projection (23-27) and (34-36) with sharply outlined side edges.

The subject of the present invention is the method of obtaining a uniform beam of electromagnetic radiation with arbitrary geometrical shape and a mechanical-optical device for application of this method to be used, depending on the required light shape and intensity, for lighting roads and sidewalks, bridges and viaducts, road crossings and bends as well as parking lots and similar objects, especially those used by the public.

Description of Polish patent No. PL78483 reveals an optical condenser used for changing intensity of and generating a beam of light rays, comprising two concave mirrors in the form of spherical cones with common optical axis that are situated opposite each other with their focal points coinciding, where one of these converging mirrors has a centric opening with diameter equaling the diameter of the beam adopted to the diameter of the output beam reflected by the second mirror. In said condenser, a change of intensity of the light ray beam occurs without changing the nature of this beam, i.e. with parallelism of rays at input and at output being maintained, while the system can be further extended forming a cascade system producing a beam with very large intensity.

Description of Polish patent No. PL186117 reveals also an optical radiation concentrator designed to generate a coherent beam of light rays with high radiation intensity and in that part of the electromagnetic waves spectrum that corresponds to the visible light radiation. The concentrator comprises coaxially juxtaposed mirrors transforming intensity of this radiation, including a convex mirror in the form of external conical side surface and a concave mirror in the form of internal conical side surface. By means of the concentrator it is possible to achieve a transformation of intensity of the light stream falling in the form of coherent beam of rays onto one of the mirrors, and if used as an attachment to a floodlight, the concentrator is capable to increase the radiation intensity up to a value allowing to provide glaring lighting to a selected surface area.

The optical devices most frequently used to form a coherent light beam of high intensity are also reflectors capable to produce a coherent beam of light within the full spectrum of visible electromagnetic light waves. Technical solution of a typical reflector is characterized with that it comprises a catoptric element in the form of spherical surface of revolution in focal point of which a point-like light source is located. Light rays emitted omnidirectionally from the light source, after being reflected from the surface of said catoptric element known also as the mirror, form a coherent beam of parallel light rays with high intensity of the light stream. On the other hand, the light rays that were emitted but not reflected from the catoptric element form the dissipated radiation transferred into the solid angle defined by the light source position and the catoptric element edge.

The objective of the invention is to provide an optical system allowing to obtain a uniform beam of electromagnetic radiation emitted by a source of artificial light that after falling onto given plane or object would produce a projection with required geometrical shape and sharp edges and allow to increase or decrease intensity of the light beam in selected areas. A further objective of the invention is to develop a simple design of a mechanical-optical device allowing to use the above method for meeting different needs of the user.

The key idea of the method of obtaining a uniform beam of electromagnetic radiation with arbitrary geometrical shape by means of a lens-based optical system according to the present invention consists in that a light-emitting source of artificial light is connected to the electric power network, and electromagnetic light rays emitted by said source, depending on the required light projection shape, are directed in the form of uniform beam of electromagnetic radiation onto appropriate input lens, preferably a cylindrical converging plano-convex lens with fixed or adjustable focal length, and light rays leaving the lens are directed onto the output set of lenses or the output panel set of lenses with fixed or adjustable orientation with respect to the input lens, i.e. inclined at angle “α” ranging from 0° to 75°, and after passing through the lens or the panel set of lenses, the rays are directed onto given plane producing a required shape of light projection with sharply outlined side edges.

As the input lens, a biconvex lens or a concavo-convex lens or a reflector or a system of reflectors is preferably used.

It is also preferable to use, as the output set of lenses, a set of plano-cylindrical lenses with diameters constant along their lengths or a set of plano-cylindrical lenses with diameters constant along their lengths but with diameters alternately differing, or alternatively a set of plano-cylindrical lenses with their diameters varying along their whole length.

It is also preferable when, in the output set of cylindrical lenses, the adjacent lenses are separated from each other, preferably by means of a minimum pressure of their sharp edges exerted on each other, dulling contact surfaces of the lenses, application of metal coating on the contact surfaces, or introducing an isolating element between them.

It is also preferable that, as the source of light, a source of electromagnetic radiation is used emitting light in the visible light range 400-800 nm, ultraviolet range 100-400 nm, or infrared range 800-15000 nm, or a detector of electromagnetic radiation, preferably a photodiode or a phototransistor.

It is preferable that the light stream leaving the optical system's input lens with variable focal length is parallel, divergent or convergent, preferably within the range from −30° to +30°.

It is also preferable that, when a panel of cylindrical lenses is used, its individual lenses are protected from direct or indirect transition of reflected radiation from one cylindrical lens to another adjacent cylindrical lens.

On the other hand, the main idea of the device for obtaining a uniform beam of electromagnetic radiation of arbitrary geometrical shape according to the present invention consists in that its optical system comprises a source of artificial light with an input converging lens situated opposite the latter, electromagnetic rays emitted by the light source and an output lens or an output lens panel constituting a set of many output lenses, preferably plano-cylindrical ones receiving said rays, while the light source is mounted in a housing provided with side guides with arms mounted on said guides slidably by means of mandrels, with lower ends of said arms connected rigidly to the converging input lens, while the housing is connected detachably with the planetary system body, connected also detachably with a replaceable segment, lower end of which is equipped with the output lens or the output lens panel so that together they are able to move rotationally with respect to the housing of the device.

It is also preferable when the output lens or output lens panel is mounted in the replaceable segment at angle α=0°-70° with respect to the plane face of the converging input lens, its body is provided with a planetary system allowing to change its orientation angle, and its housing is connected rigidly with the body by means of an external shielding element.

It is preferable when the device comprises a single LED section or a set of such LED sections containing optical systems with independent or mutually interdependent coordinated swinging motion in a selected longitudinal or transversal direction within the range of angles from 0° to 360° or simultaneously in longitudinal and transversal direction within the range of angles from 0° to 360° and is provided with a transmission, preferably a worm gear and/or strand transmission, with parameters adapted to the number and purpose of LED sections, used to adjust direction, angular position and the focal length of the input lens.

Selection of appropriate curvature and/or radius of the cylindrical lens surface and appropriate optical parameters of the lens allowed to stretch the beam of electromagnetic radiation and orient the light in a controlled way as far as e.g. the shape of illuminated surface is concerned, and as a result of appropriate separation of adjacent lenses and reduction of the area of contact between their curved surfaces, a high degree of uniformity of the properly oriented beam of electromagnetic radiation in the form of the projection of light with required geometrical shape and dimensions was obtained. Separation of the lenses prevented undesired deformation of the radiation passing through the set of these lenses, occurring at points of contact between the lenses and resulting from reflection of the radiation from these very points that play also the role of a lens with different reflection plane parameters, while the common feature of all these distortions is the unevenness of radiation stream making effective operation of many earlier devices impossible.

Among merits of the present invention one can number also the possibility to use it in the visible light wavelength range as well as in the ultraviolet, near infrared, and far infrared regime. Moreover, the method according to the present invention creates the possibility to illuminate precisely such objects of the public space such as roads, sidewalks, bridges and viaducts, road crossings, bends and curves, and parking lots by means of possibility to obtain the required light projection's geometrical shape and lighting intensity. This in turn will allow for significant reduction of electric power consumption, reaching even 80% in some cases, as the light can be directed only onto the above-listed targets. Moreover, the invention allows to reduce the cost related to construction of infrastructure required to illuminate large spaces, e.g. by significant reduction of number of lamp-posts that can be distributed at distances larger than those commonly used, and power of light sources installed on them can be reduced even to 60%. It is also possible to apply the method according to the invention in architecture, as in view the possibility to obtain a very sharp delimitation between the light beam and the non-illuminated areas, facades of buildings can be lit without illuminating windows of the residents' apartments.

Further, the capacity to provide instantaneous, smooth and automatic adjustment of length and width of the electromagnetic radiation beam creates the possibility to use the method according to the present invention also in headlights and motion detectors of both vehicles and stationary objects. Another area of possible applications of the solution provided by the invention are specialized lamps constituting sources of ultraviolet radiation and used, among other things, to disinfect footways in hospitals, greenhouses, air conditioning stations, water purification plants, and many other facilities. By replacing the electric bulb constituting the light source in the optical system with an infrared radiation source, the optical system will be capable to distribute heat with avoiding energy transfer to areas that do not need it, the feature that can be used in such applications as e.g. heating industrial shops by means of infrared (IR) rays. Further, thanks to the possibility of obtaining a very long and narrow beam of electromagnetic radiation with the profile of e.g. a widely spread-out fan, the solution according to the present invention can be used to create a narrow motion detector-based protection curtain of angular range reaching even up to 360°, thus eliminating the necessity to use multiple beams of radiation. Moreover, by replacing the typical artificial light source in the optical system with a detector, it will be possible to apply the invention in scanner-type devices or in other optical devices in which it is necessary to obtain the image of a very small area. Positioning of the light source at such an angle with respect to the input cylindrical lens that the output light beam leaving the set of output lenses of the optical system has the shape of an arc, semicircle, circle, or ring, will allow to illuminate very effectively such object as e.g. road bends, roundabouts and parts of elevations in architecture.

Another merit of the mechanical-optical device proposed hereby for the purpose of application of the method according to the invention is its simple and compact design that can be materialized in average workshop conditions.

The object of the present invention is presented in the form of examples of its embodiment in a number of figures, of which

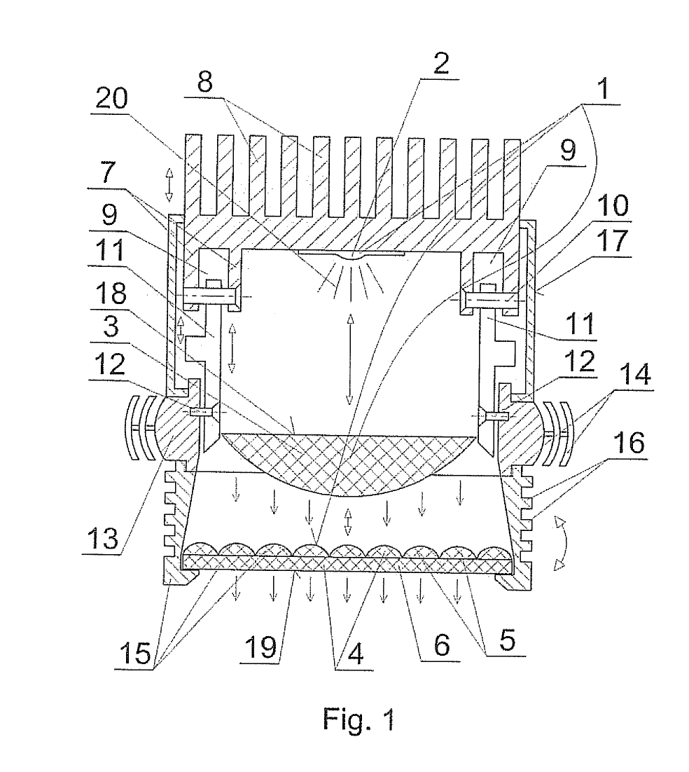

FIG. 1 shows a schematic diagram of the mechanical-optical device with adjustment of focal length of its input lens and orientation angle of its output lens allowing to obtain a uniform beam of electromagnetic radiation with rectangular shape of its projection, in axial cross-section;

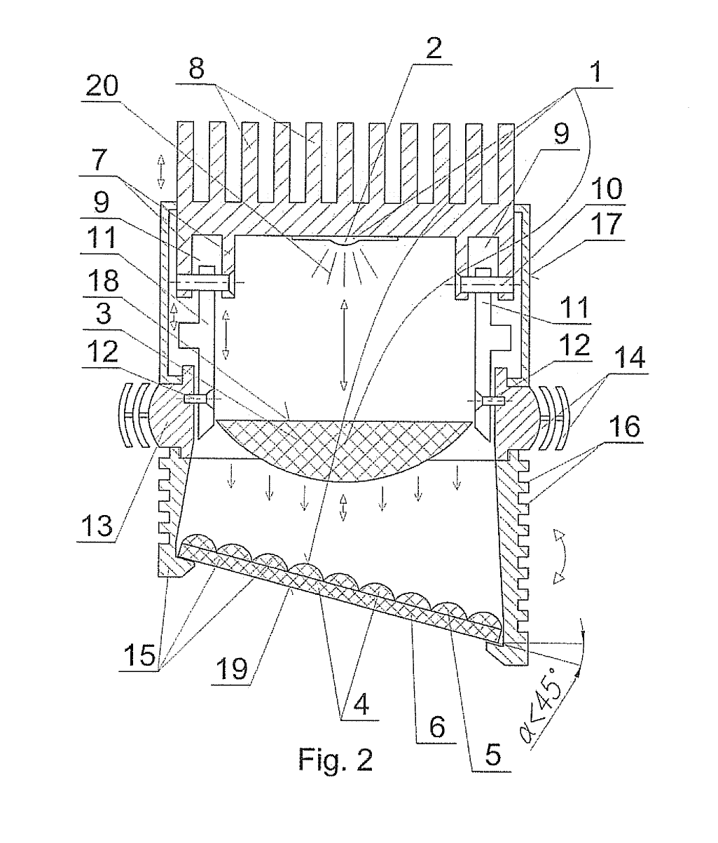

FIG. 2—schematic diagram of the same device allowing to obtain a uniform beam of electromagnetic radiation projection of which has the shape of a ring segment;

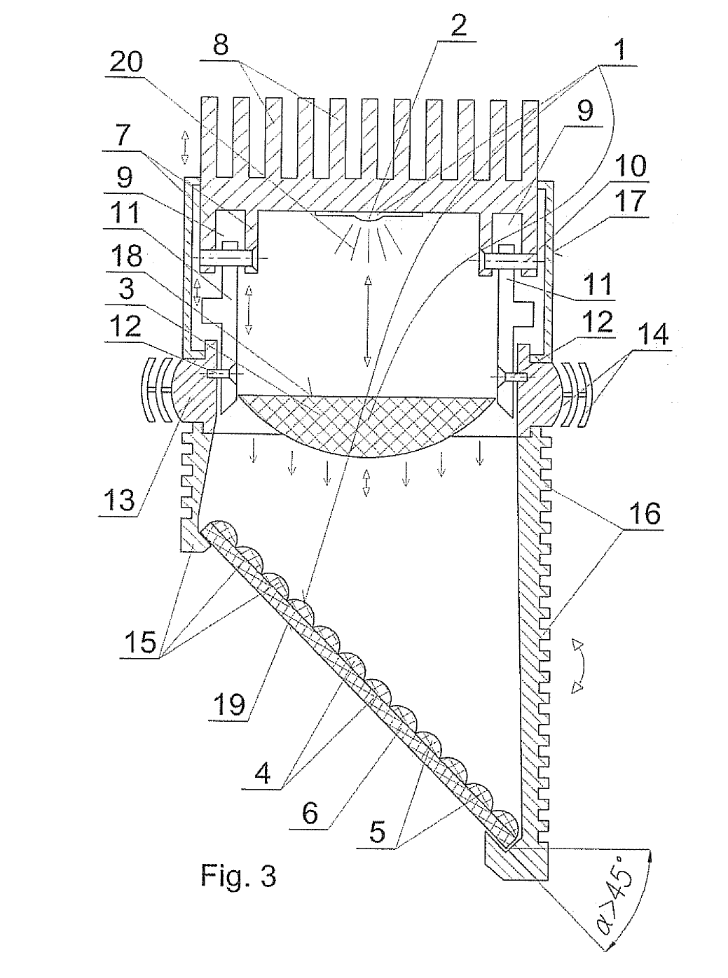

FIG. 3—schematic diagram of the same device allowing to obtain a uniform beam of electromagnetic radiation projection of which has the shape of a ring;

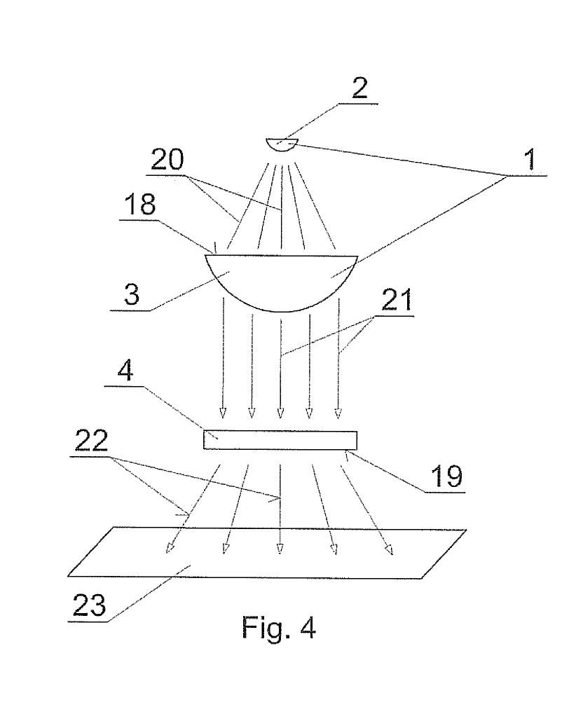

FIG. 4—schematic diagram of optical system of the device in such state of relative position of the source of electromagnetic radiation, input lens, and output lens with respect to each other that the projection of the radiated light has the shape of a significantly broadened and elongated straight line;

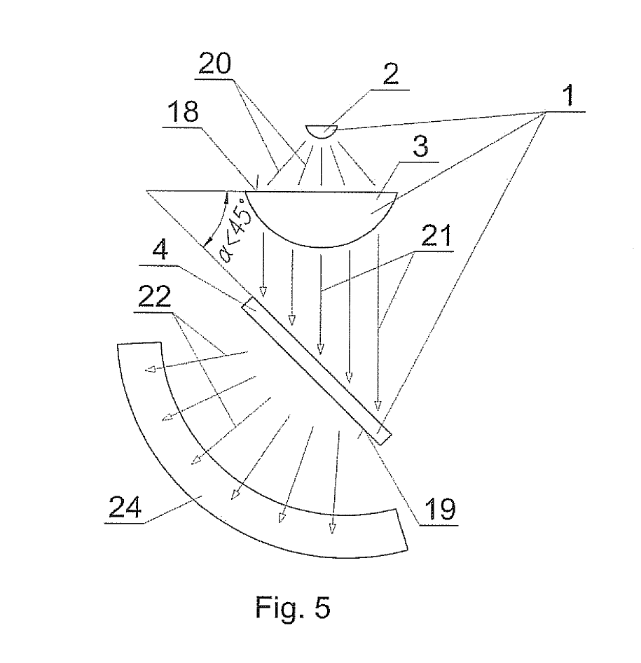

FIG. 5—schematic diagram of the same optical system in such state of relative position of the output lens with respect to the input lens that the projection of the radiated light has the shape of a ring segment;

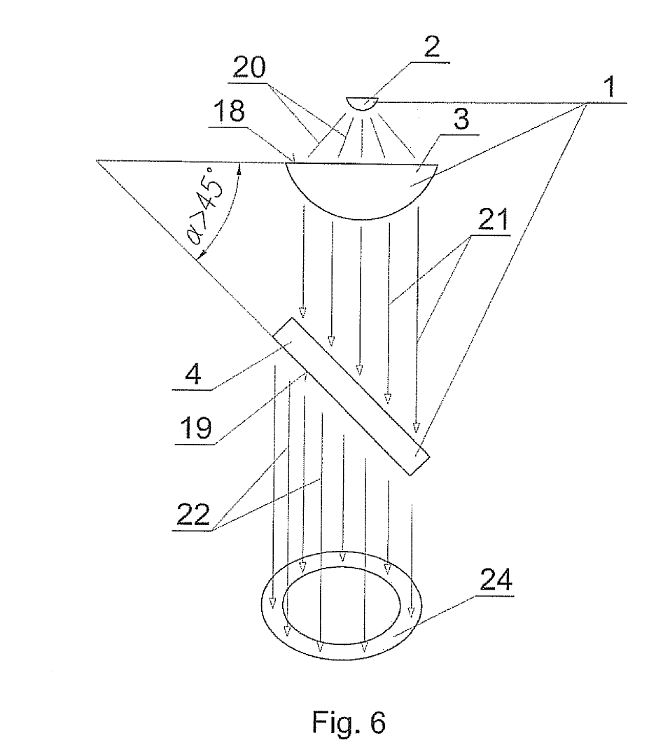

FIG. 6—schematic diagram of the same optical system in such state of relative position of the electromagnetic radiation source, the input lens and the output lens with respect to each other that the projection of the radiated light has the shape of an oval ring;

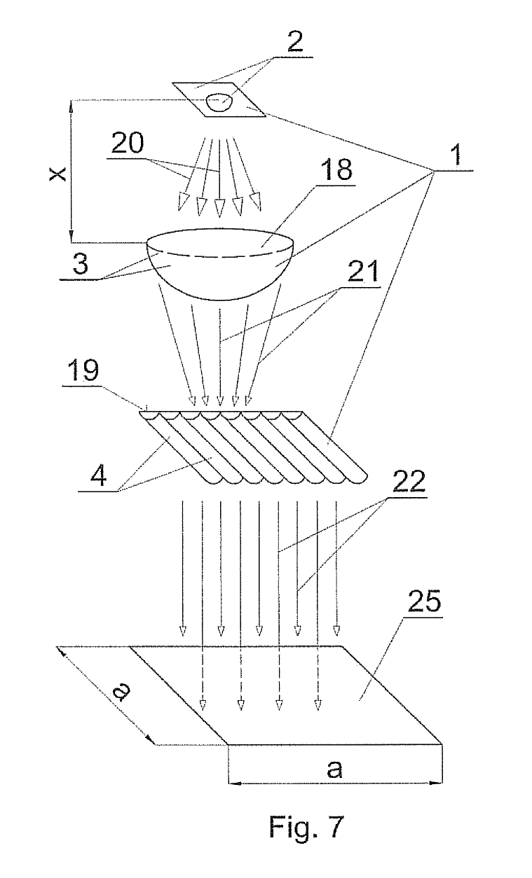

FIG. 7—schematic diagram of the same optical system in such state of relative position of the electromagnetic radiation source, the input lens and the output lens with respect to each other that the projection of the radiated light has the shape of a square;

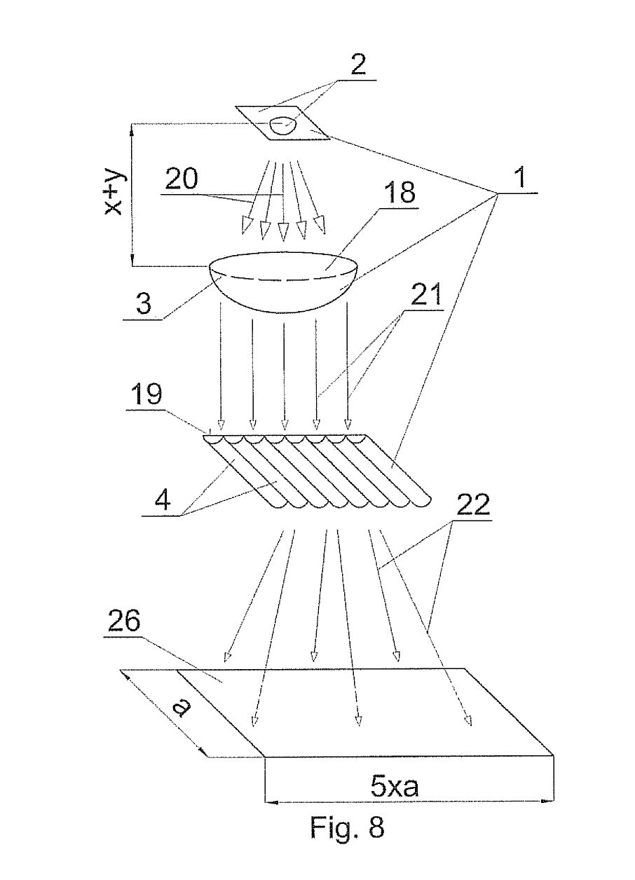

FIG. 8—schematic diagram of the same optical system in such state of relative position of the electromagnetic radiation source, the input lens and the output lens with respect to each other that the projection of the radiated light has the shape of a rectangle with length equaling five times its width;

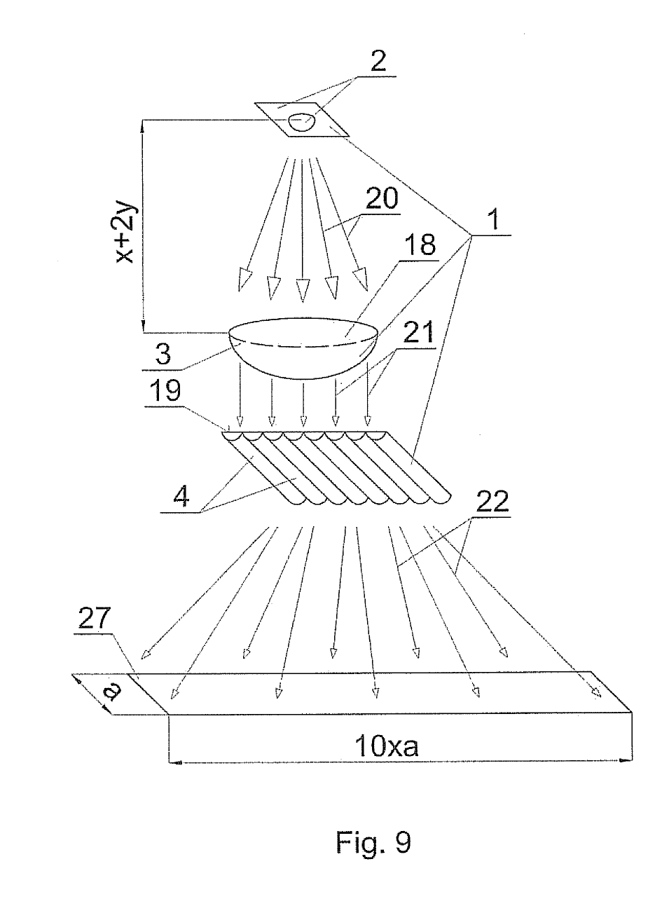

FIG. 9—schematic diagram of the same optical system in such state of relative position of the output lens with respect to the input lens that the projection of the radiated light has the shape of a rectangle with length equaling ten times its width;

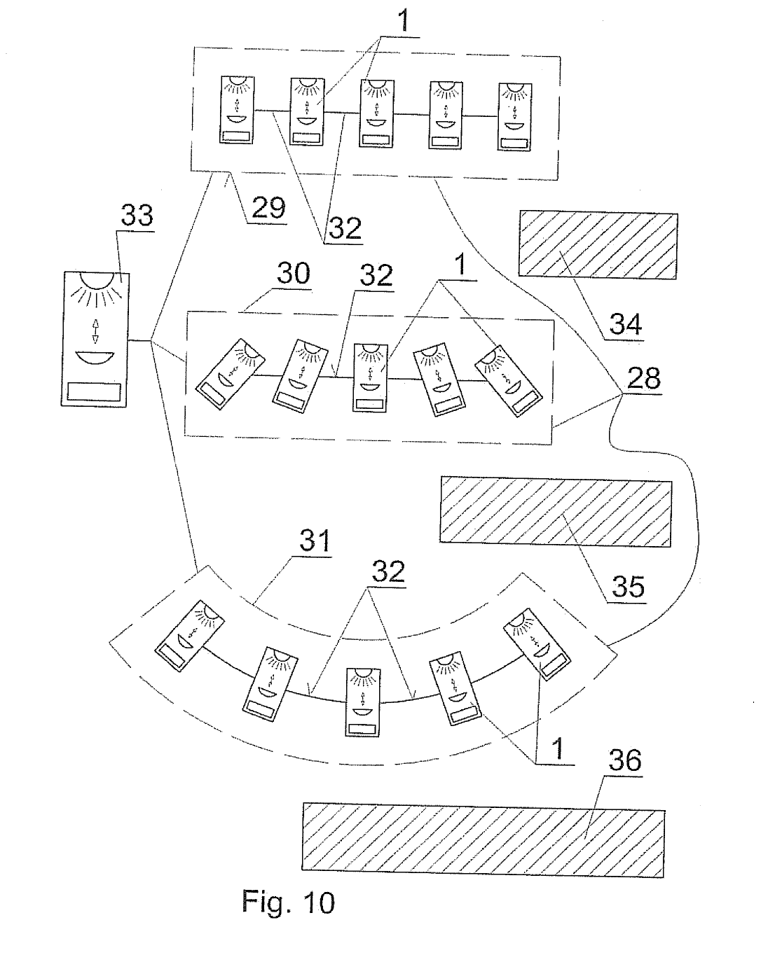

FIG. 10—schematic diagram of an optical system comprising a set of fifteen optical systems analogous to this shown in FIG. 4 connected to each other in groups of five systems each and an optical system controlling them and allowing to obtain the electromagnetic radiation projection in the form of three rectangles with different lengths depending on the user's needs;

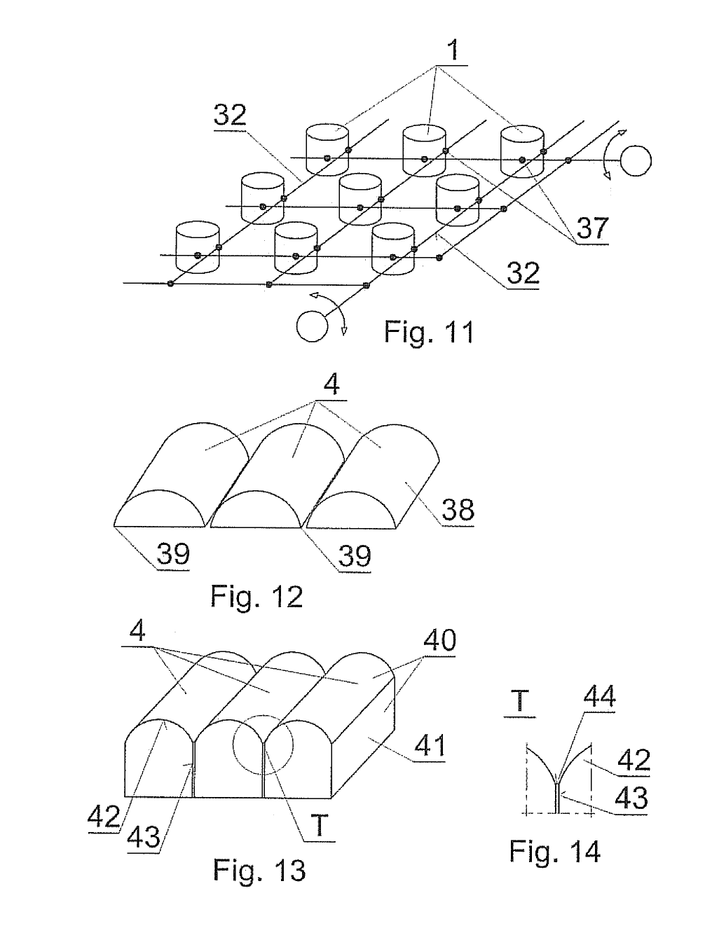

FIG. 11—schematic diagram of the system allowing to adjust the shape of electromagnetic radiation beam by means of worm gears and strands;

FIG. 12—a panel constituting the plano-cylindrical output lens, composed of a several plano-cylindrical lenses with diameters identical along the whole length, in the perspective view; FIG. 13—a variant of the panel constituting the plano-cylindrical output lens made of individual elements separated from each other and with their vertical cross-sections in the form of identical rectangles with upper sides rounded, in the perspective view;

FIG. 14—detail “T” of the same panel;

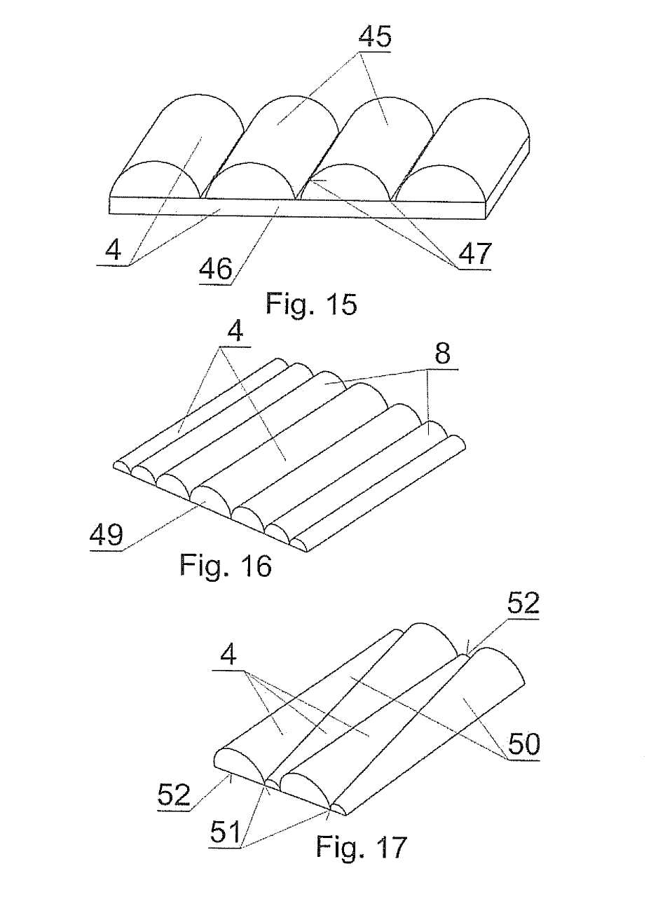

FIG. 15—another variant of the panel constituting the plano-cylindrical output lens made of several cylindrical lenses put in linear contact with each other and mounted on a rectangular plate made of the lens material, in the perspective view;

FIG. 16—a variant of the plane panel composed of plano-cylindrical lenses situated next to each other with their diameters decreasing on both sides of a central lens with the largest diameter, in the perspective view;

FIG. 17—a variant of the plane panel composed of cylindrical lenses with diameters varying along their length, in the perspective view;

FIG. 18—a spherical panel with the profile in the form of a ring segment, made of cylindrical lenses, in the perspective view;

FIG. 19—a spherical panel made of cylindrical lenses located on side surface of a cylinder;

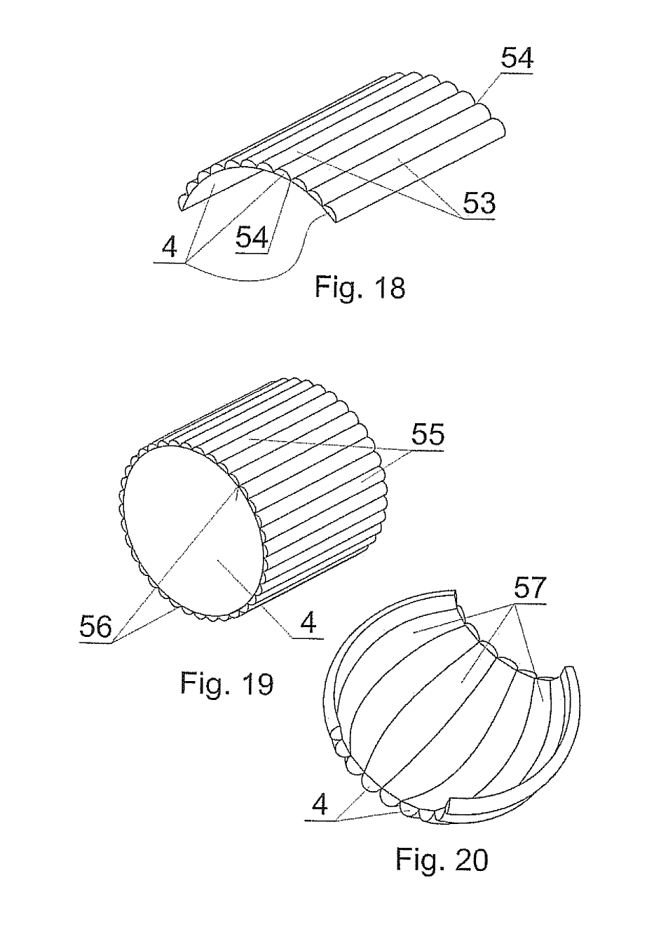

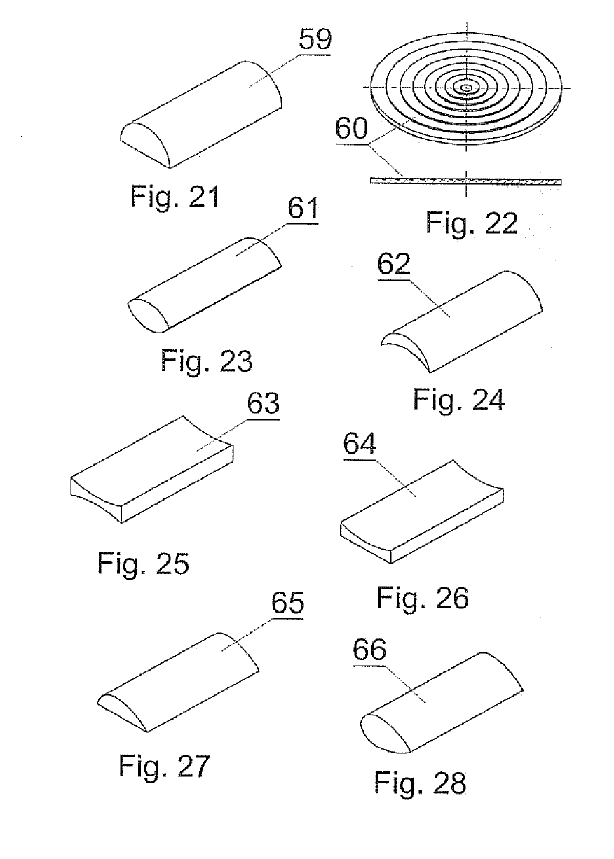

FIG. 20—aspheric panel made of cylindrical lenses with profiles in the form of a ring segment, in the perspective view. FIGS. 21-28 show forms of different input lenses, both symmetric and asymmetric with respect to their vertical and horizontal axes, of which

FIG. 21 shows a plano-cylindrical lens symmetrical in both of its planes in the perspective view;

FIG. 22—a Fresnel lens symmetrical in both of its planes, in the top view and in axial cross-section,

FIG. 23—a biconvex lens with variable convexity and symmetrical only with respect to the vertical plane, in the perspective view;

FIG. 24—a concavo-convex lens symmetrical also in its vertical plane, in the perspective view;

FIG. 25—a biconcave lens symmetrical in both of its planes, in the perspective view;

FIG. 26—a plano-concave lens symmetrical only in its vertical plane, in the perspective view;

FIG. 27—a plano-convex lens with vertical symmetry, in the perspective view;

FIG. 28—a biconcave lens with convexities asymmetrical both horizontally and vertically, in the perspective view.

For clarity, definitions of some terms used in the present patent description are given in the following, namely:
light source means on object emitting electromagnetic radiation with wavelength in the range 200-15000 nm, such as: semiconductor diode, gas-discharge tube, quartz lamp, halogen lamp, sodium lamp, mercury lamp, light bulb, fluorescent lamp, light emitting diode, infrared radiator, diode emitting ultraviolet radiation, or luminophore;
optical system means a set of two or more optical elements in the form of lenses properly situated with respect to each other and taking part in creation of an optical image in an optical device or on a given plane;
input lens means a lens converging light rays, symmetrical or asymmetrical with respect to its vertical or horizontal axis;
output lens means a cylindrical lens or a set of cylindrical lenses situated next to each other, contacting each other linearly or isolated (separated) from each other;
cylindrical lens means a single symmetrical plane or spherical lens cross section of which has a form of an oblong semi-cylindrical element or a section thereof with one of its faces being plane and with its diameter constant or variable along its length, or a set of such lenses constituting a monolith with common base;
symmetrical lens means a lens symmetrical in both vertical and horizontal plane, e.g. a cylindrical plano-convex lens, a biconcave lens and a biconvex lens or a lens symmetrical only in its vertical plane, e.g. a biconvex lens with variable convexity, a concavo-convex lens or a plano-convex lens, or a lens symmetrical only in the horizontal plane, e.g. a plano-convex lens with both its convexities variable;
catoptric element means a simplified reflector used to change direction of or give a form to a stream of electromagnetic radiation.

### EXAMPLE 1

The mechanical-optical device used for obtaining a uniform beam of electromagnetic radiation with arbitrary geometrical shape according to the invention shown in its example embodiment in FIG. 1 constitutes the optical system (1) that comprises a source of light (2) in the form of LED emitting visible light within the wavelength range 400-800 nm, a replaceable input lens (3) in the form of symmetrical plano-convex lens, and a replaceable output lens (4) in the form of a panel composed of plano-convex cylindrical lenses (5) situated next to each other, contacting linearly and located on transparent plate element (6), while the light source (2) is connected with the housing (7) provided with a cooling radiator (8) and two guides (9) with arms (11) mounted slidably on said guides on mandrels (10); lower ends of said arms are connected rigidly with the input lens (3) focal length “x” of which can be changed, and by means of pins (12) are connected with body (13) of the planetary system (14) used to change its angular position, with replaceable segment (15) screwed on its lower end and provided with output lens (4) and external cooling radiator (16), while the body (13) is connected with housing (7) by means of a shielding element (17), and the output lens (4) is situated parallel to the plane face (18) of the input lens (3).

### EXAMPLE 2

Onto body (13) of the mechanical-optical device shown in FIG. 1, a replaceable segment (15) is screwed, replaceable output lens (4) of which is oriented at angle α<45° with respect to the plane face (18) of the input lens (3) of the device, as shown in FIG. 2.

### EXAMPLE 3

Onto body (13) of the mechanical-optical device shown in FIG. 1, a replaceable segment (15) is screwed, replaceable output lens (4) of which is oriented at angle α>45° with respect to the plane face (18) of the input lens (3) of the device, as shown in FIG. 3.

Further example embodiments of the invention pertain to methods of obtaining different shapes of light projections and a uniform beam of electromagnetic radiation depending on type and relative position of input lens (3), output lens (4) and light source (2) making up the optical system (1) used in the example device shown in FIGS. 1-3, namely:

### EXAMPLE 4

In the optical system (1) used in the device described in Example 1, the plane face (19) of the cylindrical output lens (4) is positioned parallel to the plane face (18) of the converging plano-convex input lens (3), while electromagnetic rays (2) produced by the light source (2) emitting ultraviolet light in the wavelength range 100-400 nm are directed onto input lens (3), and after living it, rays (21) are directed onto the output lens (4), as a result of which the rays (22) leaving it allow to achieve a uniform beam of electromagnetic light with projection in the form of a continuous broadened line (23), as shown in FIG. 4.

### EXAMPLE 5

In the optical system (1) described in embodiment examples 1 and 4, the lower face (19) of cylindrical output lens (4) is positioned at angle α=35° with respect to the plane face (18) of the converging plano-convex input lens (3), while electromagnetic rays (20) generated by the light source (2) emitting infrared light in the wavelength range 800-15000 nm are directed onto the input lens (3) and after leaving it, rays (21) are directed onto the output lens (4), as a result of which rays (22) leaving it generate a light projection in the form of uniform beam of electromagnetic radiation with the shape of a ring segment (24), as shown in FIG. 5.

### EXAMPLE 6

In the optical system (1) described in embodiment examples 1-5, the lower face (19) of cylindrical output lens (4) is positioned at angle α=65° with respect to the plane face (18) of converging plano-convex input lens (3), while electromagnetic rays (20) generated by the light source (2) are directed onto the input lens (3), and after leaving it, rays (21) are directed on the output lens (4), as a result of which rays (22) leaving it generate a light projection in the form of uniform beam of electromagnetic radiation with the shape of an oval ring (24), as shown in FIG. 6.

### EXAMPLE 7

In the optical system (1) described in embodiment examples 1-6, the lower face (19) of the output lens (4) is positioned parallel to the plane face (18) of converging plano-convex input lens (3) situated as fixed distance “X” from the light source (2) and then, electromagnetic rays (20) generated by the source are directed on the input lens (3), and after leaving it, rays (21) are directed onto the output lens (4), as a result of which rays (22) leaving it form a uniform beam of electromagnetic radiation with projection in the form of a rectangle (25) having sides with length and width equaling “α” as shown in FIG. 7.

### EXAMPLE 8

In the optical system (1) described in embodiment examples 1-7, the lower face (19) of lens (4) is positioned parallel to the plane face (18) of converging plano-convex input lens (3) situated at increased distance with respect to this shown in FIG. 4 from the light source (2), i.e. at the distance “x+y”, after which the electromagnetic rays (20) generated by the source are directed on the input lens (3), and after leaving it, rays (21) are directed onto the output lens (4), as a result of which rays (22) leaving it form a uniform beam of electromagnetic radiation with projection in the form of a rectangle (26) with length “α” and width “5×α”, as shown in FIG. 8.

### EXAMPLE 9

In the optical system (1) described in embodiment examples 1-8, the lower face (19) of lens (4) is positioned parallel to the plane face (18) of converging plano-convex input lens (3) situated at increased distance with respect to this shown in FIG. 8 from the light source (2) i.e. at the distance “x+2y”, after which the electromagnetic rays (16) generated by the source are directed onto the input lens (3), and after leaving it, rays (21) are directed onto the output lens (4), as a result of which rays (22) leaving it form a uniform beam of electromagnetic radiation with projection in the form of a rectangle (27) with length “α” and width “10×α”, as shown in FIG. 9.

### EXAMPLE 10

Fifteen optical systems (1) described in Example 4 and constituting LED sets (28) divided into three equal LED sections (29, 30 and 31) of five systems each, are interconnected in parallel by means of strands (32) and controlled by means of one common optical system (33), where in the group (29) of five optical systems (1) identically oriented with respect to each other and situated in one plane, a uniform beam of electromagnetic radiation was obtained with light projection in the form of rectangle (34). Further, in the group (30) of five optical systems (1) situated with respect to each other at different angles, a uniform beam of electromagnetic radiation was obtained with light projection in the form of rectangle (35) elongated by about 50% with respect to rectangle (34), and in the group (31) of five optical systems (1) situated on an arc within the plane of a ring segment, a uniform beam of electromagnetic radiation was obtained with light projection in the form of rectangle (36) elongated by about 100% with respect to rectangle (34), as shown in FIG. 12, where groups (29, 30, 31) of optical systems (1) are linked to each other by means of a system of strands (32) with worm transmissions (37) allowing to change positions of the systems by their rotation, as shown in FIGS. 10 and 11.

In further example embodiments of the invention, different possible forms of the output lens are presented allowing to achieve the assumed objective of the invention, namely:

### EXAMPLE 11

The output lens (4) constitutes a set of three symmetrical plano-cylindrical lenses (38) having in the front view the form of oblong semi-cylindrical elements contacting with each other along their longitudinal edges (39), as shown in FIG. 12.

### EXAMPLE 12

The output lens (4) constitutes a set of oblong elements (40) having in the front view the form of rectangles (41) with rounded upper faces (42) and contacting with each other along their side walls (43) through elements (44) isolating (separating) them from each other, as shown in FIG. 13 and FIG. 14.

### EXAMPLE 13

The output lens (4) constitutes a panel composed of several symmetrical plano-cylindrical lenses (45) bonded to transparent plate (46) and contacting with each other along their longitudinal edges (47), as shown in FIG. 15.

### EXAMPLE 14

The output lens (4) constitutes a panel composed of seven symmetrical plano-cylindrical lenses (48) with diameters decreasing in both directions with increasing distance from the central lens (49) with the largest diameter, as shown in FIG. 16.

### EXAMPLE 15

The output lens (4) constitutes a panel composed of several plano-cylindrical lenses (50) contacting each other linearly along their side edges (51), with their diameters decreasing alternately (52), as shown in FIG. 17.

### EXAMPLE 16

The output lens (4) constitutes a spherical panel with the profile in the form of a ring segment made of several cylindrical convexo-concave lenses (53) contacting each other, with their edges (54), as shown in FIG. 18.

### EXAMPLE 17

The output lens (4) constitutes a spherical panel with the profile in the form of a ring segment on the face of which concavo-convex lenses (55) are located with identical external dimensions contacting each other linearly along their longitudinal edges (56), as shown as shown in FIG. 19.

### EXAMPLE 18

The output lens (4) constitutes an aspheric panel with the profile in the form of a ring made of cylindrical convexo-concave lenses (57) contacting each other with their edges (58), as shown in FIG. 20.

### EXAMPLE 19

In the device with optical system shown in FIG. 1, its light source (2) constituting a 4 watt LED was located at the distance of 3 cm from input lens (3) after which, at a distance of 2 cm an parallel to it, a panel of output lenses (4) was located constituting a set of plano-convex cylindrical lenses with diameter of 4 mm. As a result of such relative position of the light source (2), input lens (3), and the set of output lenses (4), at a distance 3 m from the source the beam of light was obtained projection of which had a shape of elongated rectangle with dimensions 5 m×0.35 m.

In further examples of embodiment of the optical system (1) according to the invention shown in FIGS. 21-28, various shapes of single symmetric and asymmetric lenses with different symmetry planes are presented that can be used, depending on the user's needs, for fabrication of appropriate optical system (1), including: a plano-convex cylindrical lens (59); Fresnel lens (60); symmetrical biconvex lens (61); concavo-convex lens (62); biconcave lens (63); plano-concave lens (64); asymmetrical plano-convex lens (65); and asymmetrical biconcave lens (66).

1-18. (canceled)

19. A method, of obtaining a uniform beam of electromagnetic radiation, of arbitrary geometric shape, comprising the steps of:
providing a lens optical system;
said lens optical system further comprising an artificial light source and an input lens system;
operating said artificial light source and emitting rays in the form of a uniform beam of electromagnetic radiation onto said input lens system;
said input lens system having one of a fixed and an adjustable focal length;
guiding said rays from said input lens system to an output lens system;
said output lens system having of a fixed and an adjustable position inclining at an angle (α);
said angle (α) defined as an angle ranging from 0° to 75° with respect to a direction said rays guided from said input lens system to said output lens system; and
projecting said rays from said output lens system toward an external target and generating a projection onto said external target, whereby said projection has sharply outlined side edges from said uniform beam of electromagnetic radiation.

20. The method, according to claim 19; wherein:
said input lens system is a converging cylindrical plano-convex lens system.

21. The method, according to claim 19, wherein:
said input lens system is a biconvex lens system.

22. The method, according to claim 19, wherein:
said input lens system is a concavo-convex lens system.

23. The method, according to claim 19, wherein:
said input lens system further comprises:
at least one reflector.

24. The method, according to claim 19, wherein:
said output lens system further comprises:
a set of plano-cylindrical lenses arranged with constant diameters along their respective lengths.

25. The method, according to claim 19, wherein:
said output lens system further comprises:
a set of plano-cylindrical lenses arranged with their respective diameters varying along their respective lengths.

26. The method, according to claim 19, wherein:
said output lens system utilizes a set of cylindrical lenses wherein each respective adjacent lens in said set is separated from each respective lens by at least one of a group of separation mechanisms, consisting of:
a plurality of isolating elements positioned between each respective cylindrical lens; a dulling contact surface on each respective cylindrical lens, and a system of exerting minimal pressure on a respective sharp edge of each respective c ylindrical lens.

27. The method, according to claim 19, wherein:
said artificial light source emits rays in at least one of a group of rays consisting of: visible wavelengths of 400-800 nanometers, ultraviolet wavelengths of 100-400 nanometers, and infrared wavelengths of approximately 800-15,000 nanometers.

28. The method, according to claim 19, wherein:
said input lens system has said adjustable focal length; and
said step of guiding said rays from said input lens system rays includes a further step of providing said rays in one of a form selected from a group of forms consisting of: parallel rays, divergent rays, and convergent rays, wherein said one form is in the range of −30° to +30° relative to said input from said artificial light source to said input lens system.

29. The method, according to claim 19, wherein:
said artificial light source includes a plurality of Light Emitting Diode (LED) light sources.

30. The method, according to claim 29, further comprising the steps of:
providing an operative planetary adjustment system coupled to said artificial light source; and
adjusting an orientation of said artificial light source relative to said lens input system during a use thereof.

31. The method, according to claim 30, further comprising the step of:
connecting a shielding element rigidly with said lens optical system.

32. A method, of detecting a uniform beam of electromagnetic radiation, of arbitrary geometric shape, comprising the steps of:
providing a lens optical system;
said lens optical system further comprising a detector of electromagnetic radiation and an input lens system;
said detector of electromagnetic radiation being selected from a group of detectors consisting of: a photodiode and a phototransistor;
operating said detector to receive rays in the form of a uniform beam of electromagnetic radiation onto said input lens system;
said input lens system having one of a fixed and an adjustable focal length;
guiding said rays from said input lens system to an output lens system;
said output lens system having of a fixed and an adjustable position inclining at an angle (α);
said angle (α) defined as an angle ranging from 0° to 75° with respect to a direction said rays guided to said input lens system from said output lens system; and
projecting said light rays from said output lens system toward an external target and generating a projection onto said external target, whereby said projection has sharply outlined side edges from said uniform beam of electromagnetic radiation.

33. An apparatus, operative for obtaining a uniform beam of electromagnetic radiation, of arbitrary geometric shape, comprising:
a lens optical system;
said lens optical system further comprising an operatively connected artificial light source and an input lens system;
said artificial light source emitting rays in the form of a uniform beam of electromagnetic radiation onto said input lens system;
said input lens system having one of a fixed and an adjustable focal length;
said input lens system and an output lens system arrayed operative to guide rays from said input lens system to said output lens system during a use;
said output lens system having of a fixed and an adjustable position inclining at an angle (α);
said angle (α) defined as an angle ranging from 0° to 75° with respect to a direction said rays guided from said input lens system to said output lens system; and
said apparatus enabling a projecting of said rays from said output lens system toward an external target and generating a projection onto said external target, whereby said projection has sharply outlined side edges from said uniform beam of electromagnetic radiation.

34. The apparatus, according to claim 33; wherein:
said input lens system is a converging cylindrical plano-convex lens system.

35. The apparatus, according to claim 33, wherein:
said input lens system is a biconvex lens system.

36. The apparatus, according to claim 33, wherein:
said input lens system is a concavo-convex lens system.

37. The apparatus, according to claim 33, wherein:
said input lens system further comprises:
at least one reflector.

38. The apparatus, according to claim 33, wherein:
said output lens system further comprises:
a set of plano-cylindrical lenses arranged with constant diameters along their respective lengths.

39. The apparatus, according to claim 33, wherein:
said output lens system further comprises:
a set of plano-cylindrical lenses arranged with their respective diameters varying along their respective lengths.

40. The apparatus, according to claim 33, wherein:
said output lens system utilizes a set of cylindrical lenses wherein each respective adjacent lens in said set is separated from each respective lens by at least one of a group of separation mechanisms, consisting of:
a plurality of isolating elements positioned between each respective cylindrical lens; a dulling contact surface on each respective cylindrical lens, and a system of exerting minimal pressure on a respective sharp edge of each respective c ylindrical lens.

41. The apparatus, according to claim 33, wherein:
said artificial light source emits rays in at least one of the group of rays consisting of: visible wavelengths of 400-800 nanometers, ultraviolet wavelengths of 100-400 nanometers, and infrared wavelengths of approximately 800-15,000 nanometers.

42. The apparatus, according to claim 33, wherein:
said input lens system has said adjustable focal length; and
said input lens system is operative to guide said rays in a form selected from a group of forms consisting of: parallel rays, divergent rays, and convergent rays, wherein said one form is in the range of −30° to +30° relative to said input from said artificial light source to said input lens system.

43. The apparatus, according to claim 33, wherein:
said artificial light source includes a plurality of Light Emitting Diode (LED) light sources.

44. The apparatus, according to claim 43, further comprising:
an operative planetary adjustment system coupled to said artificial light source; whereby said operative planetary adjustment system enables adjusting an orientation of said artificial light source relative to said lens input system during a use thereof.

45. The apparatus, according to claim 44, further comprising:
a shielding element rigidly with said lens optical system.
